(19) United States
(12) Patent Application Publication
(10) Pub. No.: US 2014/0023429 A1
(43) Pub. Date: Jan. 23, 2014

(54) CONNECTION MECHANISM FOR PIVOTALLY CONNECTING TWO LINK RODS

(71) Applicant: Yu Chieh LEE, Tainan City (TW)

(72) Inventor: Yu Chieh LEE, Tainan City (TW)

(21) Appl. No.: 13/556,075

(22) Filed: Jul. 23, 2012

(51) Int. Cl. F16C 11/04

(52) U.S. Cl. 403/161

(57) ABSTRACT

A connection mechanism for pivotally connecting two link rods, namely, a first link rod of a scissor linkage and a second link rod of another scissor linkage, includes a first connection seat having a fitting surface for non-rotatably bearing on an outer side surface of the first link rod facing away from the second link rod; a second connection seat having a fitting surface for non-rotatably bearing on an outer side surface of the second link rod facing away from the first link rod; and a pivot shaft being sequentially extended through and locked to the second connection seat, the second link rod, the first link rod and the first connection seat. The connection seats are non-rotatably attached to the link rods and do not rotate along with the pivot shaft when the pivot shaft is turned to connect or separate the link rods to or from each other.

### FIELD OF THE INVENTION

The present invention relates to a connection mechanism for pivotally connecting two link rods to each other.

### BACKGROUND OF THE INVENTION

A conventional connection mechanism for pivotally connecting two link rods generally includes a pivot shaft and two washers. The two washers are separately arranged on two outer side surfaces of the two link rods facing away from each other. The pivot shaft is extended through the two link rods and the two washers and locked thereto. The conventional connection mechanism with the above-described structure is disadvantageous for use because the washers tend to rotate along with the pivot shaft and cause troubles when the pivot shaft is turned to extend through or loosen from the two link rods for connecting or disconnecting them to or from each other.

### SUMMARY OF THE INVENTION

It is therefore a primary object of the present invention to provide an improved connection mechanism for pivotally connecting two link rods of two scissor linkages that enables convenient assembling and disassembling of the two link rods to or from each other, so as to eliminate the disadvantages in the conventional connection mechanism of the same purpose.

To solve the problems in the conventional connection mechanism, the connection mechanism according to the present invention for pivotally connecting two link rods, namely, a first link rod of a scissor linkage and a second link rod of another scissor linkage, includes a first connection seat having a fitting surface for non-rotatably bearing on an outer side surface of the first link rod facing away from the second link rod; a second connection seat having a fitting surface for non-rotatably bearing on an outer side surface of the second link rod facing away from the first link rod; and a pivot shaft being sequentially extended through and locked to the second connection seat, the second link rod, the first link rod and the first connection seat. Since the connection seats of the connection mechanism are non-rotatably attached to the link rods and do not rotate along with the pivot shaft, the link rods can be conveniently assembled to or disassembled from one another.

According to the present invention, the connection mechanism further includes a wear-resistant and low-friction washer arranged between the first and the second link rod; and the pivot shaft is sequentially extended through and locked to the second connection seat, the second link rod, the washer, the first link rod and the first connection seat. With the washer, the frictional contact area and the coefficient of friction between the two pivotally connected link rods are reduced to minimize the wear thereof, enabling the link rods to have prolonged service life and be conveniently turned relative to each other.

In the present invention, the pivot shaft includes a bolt and a matching nut. The bolt has an externally threaded shank extended through the second connection seat, the second link rod, the washer, the first link rod, and the first connection seat to engage with the nut. The engaged bolt and nut together constitute the pivot shaft that can stably hold to the link rods, enabling the link rods to be conveniently pivotally connected to or separated from one another and have prolonged service life.

In the present invention, the first connection seat has an outer surface facing away from the first link rod. The outer surface of the first connection seat is extended in a direction opposite to the fitting surface of the first connection seat to form a raised first locating seat, which internally defines a rotation-limiting slot matching the nut; and the nut is non-rotatably received in the rotation-limiting slot. With the nut non-rotatably received in the rotation-limiting slot, the two link rods can be easily assembled or disassembled, and it is able to effectively prevent the condition of self-loosening of the bolt from the nut. Meanwhile, the nut is not exposed from the first connection seat to ensure a beautiful appearance thereof while eliminating the risk of scratching a user or the user's clothes by the nut.

In the present invention, the second connection seat has an outer surface facing away from the second link rod. The outer surface of the second connection seat is extended in a direction opposite to the fitting surface of the second connection seat to form a raised second locating seat, which internally defines a round slot matching a head of the bolt; and the bolt head is rotatably received in the round slot. With the bolt head rotatably received in the round slot, the two link rods can be easily assembled, and it is able to prevent the bolt head from projecting out of the second connection seat to ensure a beautiful appearance thereof while eliminating the risk of scratching a user or the user's clothes by the bolt head.

In the present invention, the fitting surface of the first connection seat has two opposite sides forward extended from the fitting surface to form two first cover portions for partially covering two opposite side surfaces of the first link rod; and the fitting surface of the second connection seat has two opposite sides forward extended from the fitting surface to form two second cover portions for partially covering two opposite side surfaces of the second link rod. In this manner, the first and second connection seats can be effectively stably located on the first and second link rods, respectively, without arbitrarily rotating relative to the link rods.

The fitting surface of the first connection seat defines a first locating channel, in which the first link rod is non-rotatably fitted; and the fitting surface of the second connection seat defines a second locating channel, in which the second link rod is non-rotatably fitted.

In the present invention, the first and the second link rod are pivotally connected near respective end to each other. And, the connection mechanism further includes a first reinforcing cap fixedly fitted on the end of the first link rod to correspond and adjoin to the first connection seat, and a second reinforcing cap fixedly fitted on the end of the second link rod to correspond and adjoin to the second connection seat. The first and second reinforcing caps not only give the ends of the first and second link rods a beautiful appearance, but also prevent them from exposing to an open space to thereby eliminate the risk of scratching a user or the user's clothes by the ends of the link rods.

The first link rod is further provided near the end thereof with a fixed first locating dot, and the first reinforcing cap is internally provided with a first locating blind hole or a first undercut for correspondingly engaging with the first locating dot.

Similarly, the second link rod is further provided near the end thereof with a fixed second locating dot, and the second reinforcing cap is internally provided with a second locating blind hole or a second undercut for correspondingly engaging with the second locating dot.

According to an embodiment of the present invention, the first reinforcing cap is integrally formed with the first connection seat, and the second reinforcing cap is integrally formed with the second connection seat.

With the above arrangements, the connection mechanism of the present invention provides the advantage of allowing two link rods to be pivotally connected to or be separated from one another in a convenient manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing link rods of two scissor linkages are pivotally connected together using the connection mechanism according to the present invention;

FIG. 2 is an enlarged view of the circled area A of FIG. 1;

FIG. 3 is an exploded view of FIG. 2; and

FIG. 4 shows an example of application of the connection mechanisms of the present invention.

### DETAILED DESCRIPTION OF THE PREFERRED EMBODIMENTS

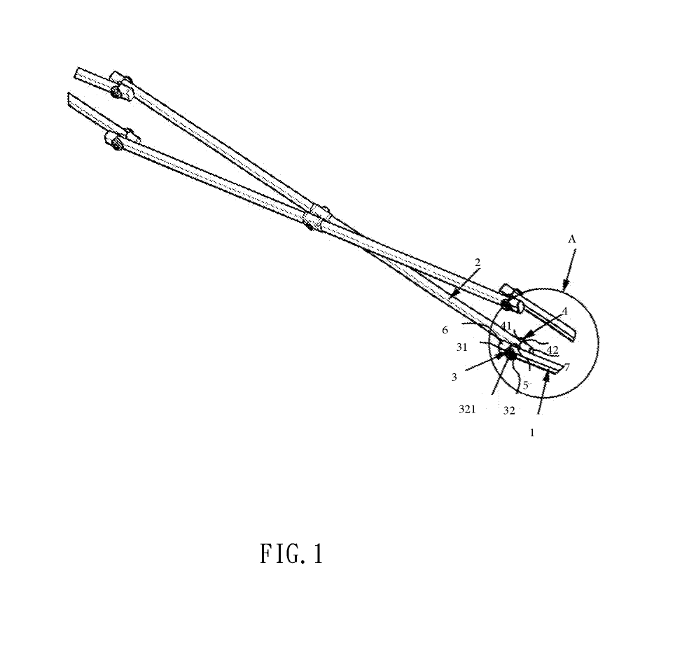

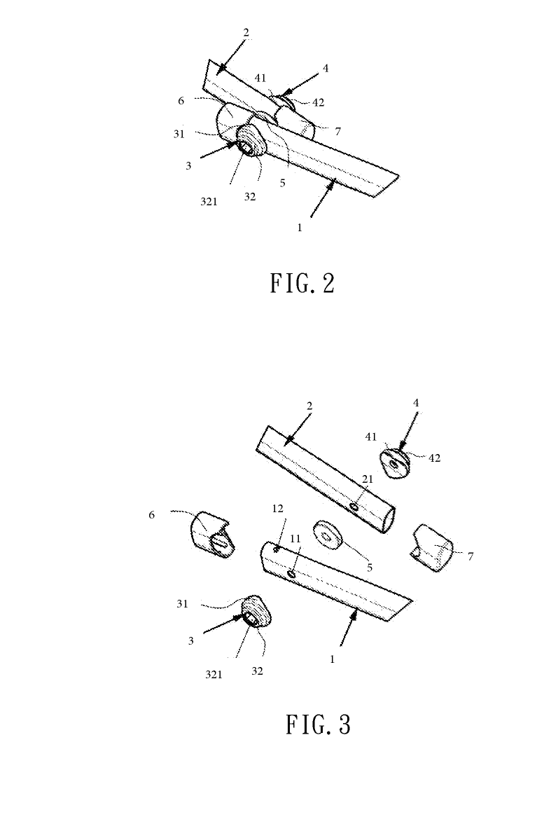

Please refer to FIG. 1. A connection mechanism according to the present invention is used to pivotally connect two link rods of two scissor linkages. More specifically, the connection mechanism of the present invention is used to pivotally connect a first link rod 1 of a first scissor linkage and a second link rod 2 of a second scissor linkage to each other. As can be seen from FIGS. 1, 2 and 3, the connection mechanism includes a first connection seat 3, a second connection seat 4, a washer 5, a first reinforcing cap 6, a second reinforcing cap 7, a bolt, and a nut.

As can be best seen from FIG. 3, the first link rod 1 has a rectangular-like cross section and is provided close to an end with a pivot hole 11. The first link rod 1 is also provided closer to the end with a fixed first locating dot 12. The second link rod 2 has a rectangular-like cross section and is provided close to an end with a pivot hole 21. The second link rod 2 is also provided closer to the end with a fixed second locating dot. The first and the second link rod 1, 2 are structurally similar to each other.

Please refer to FIGS. 1, 2 and 3. The first connection seat 3 has a fitting surface for bearing on a first side surface of the first link rod 1 facing away from the second link rod 2. Two opposite sides of the fitting surface of the first connection seat 3 are forward extended from the fitting surface to form two first cover portions 31 for partially covering two side surfaces of the first link rod 1 adjoining the first side surface. Inner surfaces of the two first cover portions 31 are configured corresponding to the profile of the first link rod 1. The first connection seat 3 has an outer surface facing away from the first link rod 1. The outer surface of the first connection seat 3 is extended in a direction opposite to the first cover portions 31 to form a raised first locating seat 32, which internally defines a rotation-limiting slot 321.

The second connection seat 4 has a fitting surface for bearing on a second side surface of the second link rod 2 facing away from the first link rod 1. Two opposite sides of the fitting surface of the second connection seat 4 are forward extended from the fitting surface to form two second cover portions 41 for partially covering two side surfaces of the second link rod 2 adjoining the second side surface. Inner surfaces of the two second cover portions 41 are configured corresponding to the profile of the second link rod 2. The second connection seat 4 has an outer surface facing away from the second link rod 2. The outer surface of the second connection seat 3 is extended in a direction opposite to the second cover portions 41 to form a raised second locating seat 42, which internally defines a round slot.

The washer 5 is wear-resistant and low-friction and is arranged between the first link rod 1 and the second link rod 2.

The nut is non-rotatably received in the rotation-limiting slot 321, while a head of the bolt is rotatably received in the round slot. The bolt has an externally threaded shank being extended through the second connection seat 4, the pivot hole 21 on the second link rod 2, the washer 5, the pivot hole 11 on the first link rod 1, and the first connection seat 3 to engage with the nut.

The first reinforcing cap 6 is internally provided on a side wall with a first locating blind hole, with which the first locating dot 12 is engaged for the first reinforcing cap 6 to fixedly fit on the end of the first link rod 1. The first reinforcing cap 6 is so configured that a part of its rim matches and fitly contacts with a part of the peripheral edge of the first connection seat 3, while another part of its rim matches and fitly contacts with a part of the peripheral edge of the washer 5.

The second reinforcing cap 7 is internally provided on a side wall with a second locating blind hole, with which the second locating dot is engaged for the second reinforcing cap 7 to fixedly fit on the end of the second link rod 2. The second reinforcing cap 7 is so configured that a part of its rim matches and fitly contacts with a part of the peripheral edge of the second connection seat 4, while another part of its rim matches and fitly contacts with another part of the peripheral edge of the washer 5.

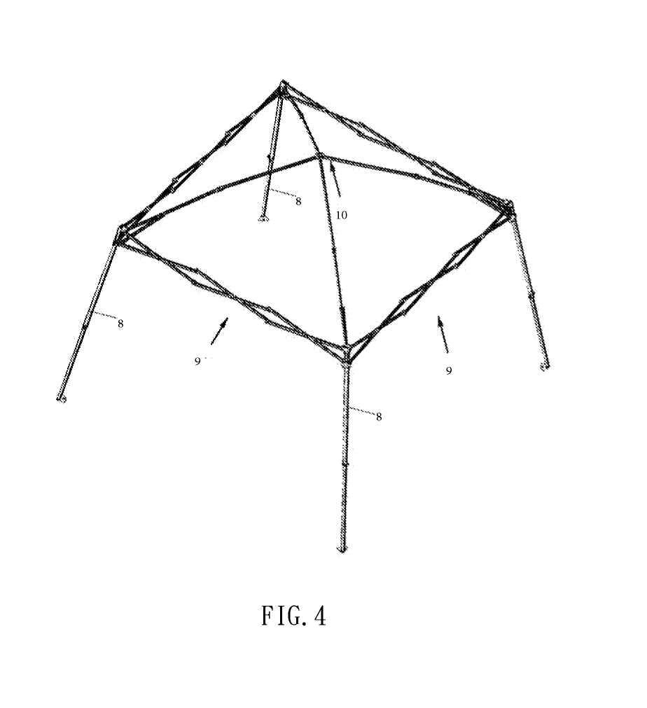

FIG. 4 shows an example of application of the connection mechanism according to the present invention in a foldable tent. The foldable tent includes four posts 8, four sets of foldable connection devices 9, and a foldable roof frame 10.

The posts 8 are telescopic posts and respectively have a fixed joint provided on an upper end thereof, and a slidable joint movably fitted therearound. Each of the slidable joints is provided with a locking member, with which the slidable joint can be locked to a position relative to a corresponding post. When the locking member is unlocked, the slidable joint is allowed to slide upward and downward along the post.

Any two adjacent posts 8 have one set of the foldable connection device 9 connected to between them. Each set of the foldable connection device 9 includes three scissor linkages. Two end portions at one side of the first scissor linkage are separately pivotally connected to the fixed joint and the slidable joint on one of the two adjacent posts 8. Two end portions at one side of the second scissor linkage are separately pivotally connected to two end portions at another side of the first scissor linkage. Two end portions at one side of the third scissor linkage are separately pivotally connected to two end portions at another side of the second scissor linkage, while two end portions at another side of the third scissor linkage are separately pivotally connected to the fixed and the slidable joint on the other one of the two adjacent posts.

The foldable roof frame 10 includes a top member, four sets of struts, and four stretchers. Each set of struts includes an upper strut and a lower strut. The upper strut has an upper end pivotally connected to the top member and a lower end pivotally connected to an upper end of the lower strut. The lower strut is pivotally connected at a lower end to the fixed joint on one of the four posts. Each of the stretchers has a lower end pivotally connected to the slidable joint on a corresponding post, and an upper end pivotally connected to a corresponding lower strut.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A connection mechanism for pivotally connecting two link rods, namely, a first link rod of a scissor linkage and a second link rod of another scissor linkage, comprising:
a first connection seat having a fitting surface for non-rotatably bearing on an outer side surface of the first link rod facing away from the second link rod;
a second connection seat having a fitting surface for non-rotatably bearing on an outer side surface of the second link rod facing away from the first link rod; and
a pivot shaft being sequentially extended through the second connection seat, the second link rod, the first link rod, and the first connection seat.

2. The connection mechanism for pivotally connecting two link rods as claimed in claim 1, further comprising a wear-resistant and low-friction washer arranged between the first and the second link rod; wherein the pivot shaft is sequentially extended through the second connection seat, the second link rod, the washer, the first link rod, and the first connection seat.

3. The connection mechanism for pivotally connecting two link rods as claimed in claim 2, wherein the pivot shaft includes a bolt and a matching nut; the bolt having an externally threaded shank extended through the second connection seat, the second link rod, the washer, the first link rod, and the first connection seat to engage with the nut.

4. The connection mechanism for pivotally connecting two link rods as claimed in claim 3, wherein the first connection seat has an outer surface facing away from the first link rod; the outer surface of the first connection seat being extended in a direction opposite to the fitting surface of the first connection seat to form a raised first locating seat, which internally defines a rotation-limiting slot matching the nut; and the nut being non-rotatably received in the rotation-limiting slot.

5. The connection mechanism for pivotally connecting two link rods as claimed in claim 3, wherein the second connection seat has an outer surface facing away from the second link rod; the outer surface of the second connection seat being extended in a direction opposite to the fitting surface of the second connection seat to form a raised second locating seat, which internally defines a round slot matching a head of the bolt; and the bolt head being rotatably received in the round slot.

6. The connection mechanism for pivotally connecting two link rods as claimed in claim 1, wherein the fitting surface of the first connection seat has two opposite sides forward extended from the fitting surface to form two first cover portions for partially covering two opposite side surfaces of the first link rod; and the fitting surface of the second connection seat has two opposite sides forward extended from the fitting surface to form two second cover portions for partially covering two opposite side surfaces of the second link rod.

7. The connection mechanism for pivotally connecting two link rods as claimed in claim 1, wherein the fitting surface of the first connection seat defines a first locating channel, in which the first link rod is non-rotatably fitted; and the fitting surface of the second connection seat defines a second locating channel, in which the second link rod is non-rotatably fitted.

8. The connection mechanism for pivotally connecting two link rods as claimed in claim 1, wherein the first and the second link rod are pivotally connected near respective end to each other; and wherein the connection mechanism further comprises a first reinforcing cap fixedly fitted on the end of the first link rod to correspond and adjoin to the first connection seat, and a second reinforcing cap fixedly fitted on the end of the second link rod to correspond and adjoin to the second connection seat.

9. The connection mechanism for pivotally connecting two link rods as claimed in claim 8, wherein the first link rod is further provided near the end thereof with a fixed first locating dot, and the first reinforcing cap is internally provided with a first locating blind hole or a first undercut for correspondingly engaging with the first locating dot; and wherein the second link rod is further provided near the end thereof with a fixed second locating dot, and the second reinforcing cap is internally provided with a second locating blind hole or a second undercut for correspondingly engaging with the second locating dot.

10. The connection mechanism for pivotally connecting two link rods as claimed in claim 8, wherein the first reinforcing cap is integrally formed with the first connection seat, and the second reinforcing cap is integrally formed with the second connection seat.
